(19) United States
(12) Patent Application Publication
(10) Pub. No.: US 2025/0211015 A1
(43) Pub. Date: Jun. 26, 2025

(54) CHARGE CONTROL DEVICE

(71) Applicant: TOYOTA JIDOSHA KABUSHIKI KAISHA, Toyota-shi (JP)

(72) Inventor: Yusuke MIZUGUCHI, Nagoya-shi (JP)

(73) Assignee: TOYOTA JIDOSHA KABUSHIKI KAISHA, Toyota-shi (JP)

(21) Appl. No.: 18/954,828

(22) Filed: Nov. 21, 2024

(30) Foreign Application Priority Data
Dec. 26, 2023 (JP) 2023-219059

(51) Int. Cl. H02J 7/00; H01M 10/0525; H01M 10/44

(52) U.S. Cl. CPC H02J 7/00712; H01M 10/0525; H01M 10/44; H01M 10/443; H02J 7/0063; H02J 7/0068; H02J 2207/20

(57) ABSTRACT

A charge control device is configured to control charging of a lithium ion battery, estimate an inflow current flowing into the lithium ion battery when a current flowing through a load stops, derive a protective charging current that is a maximum value of charging current not to cause the lithium ion battery to form lithium deposition, calculate a charging upper limit current based on the protective charging current and the inflow current, the charging upper limit current being an upper limit of current to charge the lithium ion battery, and control charging of the lithium ion battery based on a limit electric power calculated from the charging upper limit current and a voltage of the lithium ion battery.

### CROSS-REFERENCE TO RELATED APPLICATION

This application claims priority to Japanese Patent Application No. 2023-219059 filed on Dec. 26, 2023, incorporated herein by reference in its entirety.

### BACKGROUND

### 1. Technical Field

The disclosure relates to a charge control device that controls charging of a lithium ion battery.

### 2. Description of Related Art

Japanese Unexamined Patent Application Publication No. 2011-125210 (JP 2011-125210 A) describes a charge discharge controller capable of improving controllability of charge-discharge operation while sufficiently protecting the performance of a lithium ion battery. The charge discharge controller uses feedforward control and feedback control in combination. In the feedforward control, stable control is executed by using an input/output map of a battery. In the feedback control, limitations based on a limit value are applied in a case where the feedforward control is difficult.

### SUMMARY

The charge discharge controller described in JP 2011-125210 A controls the charging and discharging of a lithium ion battery by executing feedback control such that a charging current does not exceed an upper limit current obtained from the charging current, in order not to form lithium deposition in the lithium ion battery.

However, in a system capable of performing charging of a lithium ion battery from a generator and supplying electric power to a load from the generator in parallel, a load-side consumption current may significantly reduce (for example, the operation of a load stops) during charging of the lithium ion battery. In this case, the amount of current (surplus current) not consumed by a load flows into the lithium ion battery; however, if the surplus current is large, there is a possibility that the feedback control cannot be made in time and, therefore, a charging current exceeds an upper limit current for not forming lithium deposition.

The disclosure provides a charge control device capable of controlling charging of a lithium ion battery such that, even when a charging current increases with a reduction in a load-side consumption current during charging of the lithium ion battery, the charging current does not exceed an upper limit current for not forming lithium deposition.

A first aspect of the disclosure is a charge control device configured to control charging of a lithium ion battery. The charge control device includes: a first processing unit configured to estimate an inflow current flowing into the lithium ion battery when a current flowing through a load stops; a second processing unit configured to derive a protective charging current that is a maximum value of charging current not to cause the lithium ion battery to form lithium deposition; a third processing unit configured to calculate a charging upper limit current based on the protective charging current and the inflow current, the charging upper limit current being an upper limit of current to charge the lithium ion battery; and a fourth processing unit configured to control charging of the lithium ion battery based on a limit electric power calculated from the charging upper limit current and a voltage of the lithium ion battery.

A second aspect of the disclosure is a charge control device configured to control charging of a lithium ion battery. The charge control device includes an electronic control unit. The electronic control unit is configured to: estimate an inflow current flowing into the lithium ion battery when a current flowing through a load stops; derive a protective charging current that is a maximum value of charging current not to cause the lithium ion battery to form lithium deposition; calculate a charging upper limit current based on the protective charging current and the inflow current, the charging upper limit current being an upper limit of current to charge the lithium ion battery; and control charging of the lithium ion battery based on a limit electric power calculated from the charging upper limit current and a voltage of the lithium ion battery.

According to the first aspect and the second aspect of the disclosure, even when a current consumption of a load stops during charging of a lithium ion battery and, therefore, a charging current of the lithium ion battery increases, it is possible to control the charging of the lithium ion battery such that the charging current does not exceed an upper limit current for not forming lithium deposition.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram of a charge controller and its peripheral components according to an embodiment of the disclosure; and

FIG. 2 is a process flowchart of charge control for a lithium ion battery, which the charge controller executes.

### DETAILED DESCRIPTION OF EMBODIMENTS

A charge controller according to the disclosure assumes a situation that, in a case where charging of a lithium ion battery and supply of electric power to a load are being performed with a power supply, a current flowing into the lithium ion battery increases as a result of a stop of current consumption of the load, and obtains in advance a charging upper limit current at the time of such a situation and then controls the charging of the lithium ion battery. Thus, it is possible to avoid formation of lithium deposition in the lithium ion battery. Hereinafter, an embodiment of the disclosure will be described in detail with reference to the accompanying drawings.

### EMBODIMENT

### Configuration

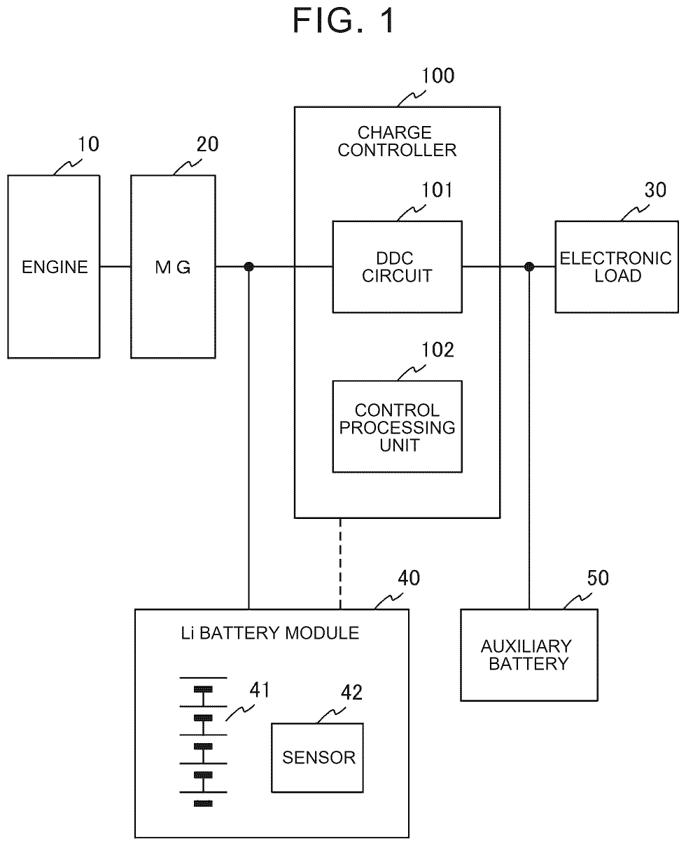

FIG. 1 is a functional block diagram of a charge controller 100 and its peripheral components according to the embodiment of the disclosure. FIG. 1 shows an example in which a lithium ion battery 41 mounted on a vehicle is controlled by the charge controller 100. The functional blocks illustrated in FIG. 1 include an engine 10, a motor generator (MG) 20, an electronic load 30, an Li battery module 40, an auxiliary battery 50, and the charge controller 100.

The engine 10 is an internal combustion engine that is a power source of the vehicle. The engine 10 is started by the motor generator (MG) 20 or the like.

The motor generator (MG) 20 is a motor generator including both a motor function for starting the engine 10 and a generator function for generating electric power by being driven by the power of the engine 10 or regenerative operation. The motor generator (MG) 20 exercises the motor function by using electric power supplied from the Li battery module 40.

The electronic load 30 includes various devices, systems, and the like that are mounted on the vehicle and that consume electric power. The electronic load 30 is configured to operate on at least any one of electric power generated by the motor generator (MG) 20, electric power supplied from the Li battery module 40 via the charge controller 100, and electric power stored in the auxiliary battery 50. Examples of the electronic load 30 include auxiliary devices (an air conditioning device, a lighting device, and the like) other than those for driving the vehicle.

The Li battery module 40 is a unit including a secondary battery configured to be chargeable and dischargeable. The Li battery module 40 includes a lithium ion battery 41 and a sensor 42. The lithium ion battery 41 is a secondary battery and has, for example, a stack configuration in which a plurality of lithium ion battery cells is connected in series. The sensor 42 has a configuration for detecting the status of the lithium ion battery 41. Various sensors are used for the sensor 42. Various sensors include a voltage sensor that monitors the voltage of the lithium ion battery 41, a current sensor that monitors a current flowing into or out from the lithium ion battery 41, a temperature sensor that monitors the temperature of the lithium ion battery 41, and the like.

The Li battery module 40 stores electric power output from the motor generator (MG) 20 and outputs electric power stored in itself to the charge controller 100. Examples of the Li battery module 40 include a battery module with a rated voltage of 48 V, used in a so-called mild hybrid system.

The auxiliary battery 50 is, for example, a secondary battery configured to be chargeable and dischargeable, such as a lead acid battery and a lithium ion battery. The auxiliary battery 50 stores electric power output from the charge controller 100 and supplies electric power stored in itself to the electronic load 30. Examples of the auxiliary battery 50 include a battery with a rated voltage of 12 V.

The charge controller 100 has a configuration for controlling the charging of the lithium ion battery 41 of the Li battery module 40. The charge controller 100 includes a DDC circuit 101 and a control processing unit 102.

The DDC circuit 101 is a step-down DC-DC converter that converts input electric power into a predetermined voltage and outputs the electric power. The DDC circuit 101 is disposed between both the motor generator (MG) 20 and the Li battery module 40 and both the electronic load 30 and the auxiliary battery 50. The DDC circuit 101 steps down 48 V electric power input from the motor generator (MG) 20 and the Li battery module 40 to 12 V electric power and outputs the 12 V electric power to the electronic load 30 and the auxiliary battery 50. The operation of the DDC circuit 101 is controlled by the control processing unit 102.

The control processing unit 102 acquires the status (voltage, current, temperature) of the lithium ion battery 41 from the sensor 42 of the Li battery module 40. The control processing unit 102 acquires the value of current flowing from the DDC circuit 101 toward the electronic load 30 (and the auxiliary battery 50) (hereinafter, referred to as “12 V current”). The 12 V current can be acquired with a current sensor (not shown) provided at an output stage of the DDC circuit 101. Then, the control processing unit 102 controls the charging of the lithium ion battery 41 based on the status of the lithium ion battery 41 and the 12 V current. Charge control for the lithium ion battery 41 will be described later.

Part or whole of the above-described charge controller 100 can be typically made up of an electronic control unit (ECU) including a processor, such as a microcontroller, a memory, an input/output interface, and the like. The electronic control unit is capable of implementing one or some or all of the above-described functions by the processor reading programs stored in the memory and running the programs.

### Control

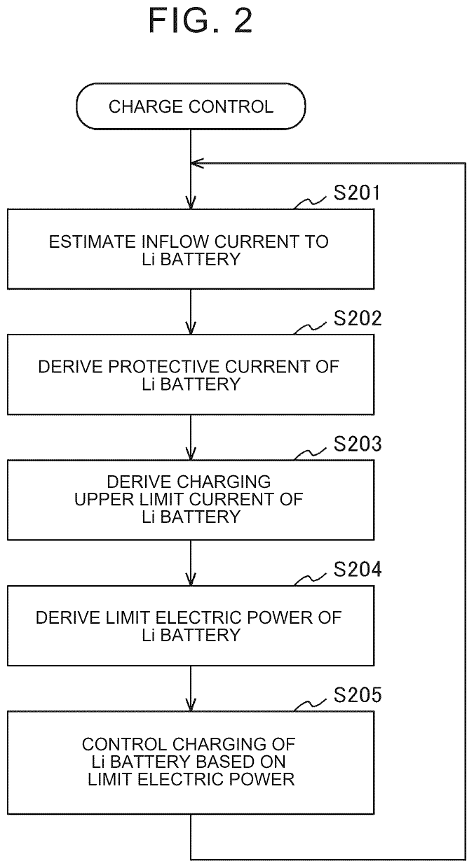

Next, control that the charge controller 100 according to the present embodiment executes will be described further with reference to FIG. 2. FIG. 2 is a flowchart that illustrates the procedure of charge control for the lithium ion battery 41, which the control processing unit 102 of the charge controller 100 executes.

Charge control for the lithium ion battery 41, illustrated in FIG. 2, is, for example, started when the system of the vehicle is started, and is repeatedly executed at predetermined timing (certain intervals) until the system of the vehicle stops.

### Step S201

The control processing unit 102 of the charge controller 100 estimates an inflow current to the lithium ion battery 41 based on a 12 V current output from the DDC circuit 101 (first process). The inflow current is assumed to increase when the electronic load 30 stops. The inflow current (hereinafter, referred to as “estimated inflow current”) can be estimated through the following expression [1] by further using a current conversion factor and a DDC efficiency factor.

$$( Estimated inflow current ) = ( 12 V current ) \times ( Current conversion factor ) \times ( DDC efficiency factor ) \qquad [ 1 ]$$

Here, the current conversion factor is a factor (48 V/12 V) for converting the value of 12 V current to the value of current (hereinafter, referred to as “48 V current”) flowing from the motor generator (MG) 20 toward the DDC circuit 101. The DDC efficiency factor is a factor according to a conversion efficiency in the DDC circuit 101. In a case of a system in which the DDC circuit 101 does not perform step-down operation, a current conversion factor may be omitted.

Once the inflow current to the lithium ion battery 41 is estimated by the control processing unit 102, the process proceeds to step S202.

### Step S202

The control processing unit 102 of the charge controller 100 derives an Li deposition protective charging current of the lithium ion battery 41 (second process). The Li deposition protective charging current is a maximum value of charging current with which the lithium ion battery 41 can be charged without forming lithium deposition. The Li deposition protective charging current is derived based on the voltage, current, and temperature of the lithium ion battery 41 at the time of derivation, and additionally a state of charge (SOC) computed from these pieces of information. Various methods can be used to derive the Li deposition protective charging current.

Once the Li deposition protective charging current for the lithium ion battery 41 is derived by the control processing unit 102, the process proceeds to step S203.

### Step S203

The control processing unit 102 of the charge controller 100 derives a charging upper limit current of the lithium ion battery 41 (third process). The charging upper limit current is an upper limit of charging current with which the lithium ion battery 41 can be charged without forming lithium deposition, in consideration of an increased amount of current toward the lithium ion battery 41 in a case where current consumption stops as a result of, for example, a stop of operation of the electronic load 30. The charging upper limit current is derived through the following expression [2] based on the estimated inflow current estimated in step S201 and the Li deposition protective charging current derived in step S202.

(Charging upper limit current)=(Li deposition protective charging current)−(Estimated inflow current) [2]

Once the charging upper limit current of the lithium ion battery 41 is derived by the control processing unit 102, the process proceeds to step S204.

### Step S204

The control processing unit 102 of the charge controller 100 derives a limit electric power of the lithium ion battery 41 (fourth process). The limit electric power indicates a charging power with which the lithium ion battery 41 can be charged without forming lithium deposition, in consideration of a stop of operation of the electronic load 30, or the like. A limit electric power is derived through the following expression [3] based on the charging upper limit current derived in step S203 and the voltage (battery voltage) of the lithium ion battery 41.

(Limit electric power)=(Charging upper limit current)×(Battery voltage) [3]

Once the limit electric power of the lithium ion battery 41 is derived by the control processing unit 102, the process proceeds to step S205.

### Step S205

The control processing unit 102 of the charge controller 100 controls the charging of the lithium ion battery 41 based on the limit electric power derived in step S204 (fourth process). Once charge control for the lithium ion battery 41 based on the limit electric power is executed by the control processing unit 102, the process proceeds to step S201.

### Operation and Advantageous Effects

As described above, with the charge controller 100 according to the embodiment of the disclosure, the charging of the lithium ion battery 41 is controlled by using a charging power set in advance in a range in which lithium deposition is not formed in the lithium ion battery 41 based on a charging current obtained on the assumption that a current being consumed by the electronic load 30 flows into the lithium ion battery 41 (feedforward control).

With this control, for example, in a state where charging of the lithium ion battery 41 and supplying of electric power to the electronic load 30 are being performed by using electric power generated by the motor generator (MG) 20, even when an inflow current to the lithium ion battery 41 steeply increases as a result of a stop or significant reduction of current consumption of the electronic load 30, it is possible to continue the charging of the lithium ion battery 41 without forming lithium deposition.

The embodiment of the disclosure has been described above; however, the disclosure is not limited to only the charge controller. The disclosure may be regarded as a method that is executed by the charge controller including a processor, a memory, and the like, a program for executing the method, a non-transitory computer-readable storage medium storing the program, or a vehicle on which the charge controller is mounted.

The charge controller according to the disclosure is usable when the charging of the lithium ion battery is intended to be controlled without forming lithium deposition.

What is claimed is:

1. A charge control device configured to control charging of a lithium ion battery, the charge control device comprising:
a first processing unit configured to estimate an inflow current flowing into the lithium ion battery when a current flowing through a load stops;
a second processing unit configured to derive a protective charging current that is a maximum value of charging current not to cause the lithium ion battery to form lithium deposition;
a third processing unit configured to calculate a charging upper limit current based on the protective charging current and the inflow current, the charging upper limit current being an upper limit of current to charge the lithium ion battery; and
a fourth processing unit configured to control charging of the lithium ion battery based on a limit electric power calculated from the charging upper limit current and a voltage of the lithium ion battery.

2. The charge control device according to claim 1, wherein the second processing unit is configured to derive the protective charging current based on at least one of a voltage, a current, a temperature, and a state of charge of the lithium ion battery.

3. The charge control device according to claim 1, wherein:
the lithium ion battery and the load are connected via a DC-DC converter; and
the first processing unit is configured to estimate the inflow current based on a current flowing through the load and a conversion efficiency of the DC-DC converter.

4. The charge control device according to claim 3, wherein:
the DC-DC converter is of a step-down type; and
the first processing unit is configured to estimate the inflow current based on a current conversion factor.

5. A charge control device configured to control charging of a lithium ion battery, the charge control device comprising an electronic control unit configured to:
estimate an inflow current flowing into the lithium ion battery when a current flowing through a load stops;
derive a protective charging current that is a maximum value of charging current not to cause the lithium ion battery to form lithium deposition;
calculate a charging upper limit current based on the protective charging current and the inflow current, the charging upper limit current being an upper limit of current to charge the lithium ion battery; and
control charging of the lithium ion battery based on a limit electric power calculated from the charging upper limit current and a voltage of the lithium ion battery.

6. The charge control device according to claim 5, wherein the electronic control unit is configured to derive the protective charging current based on at least one of a voltage, a current, a temperature, and a state of charge of the lithium ion battery.

7. The charge control device according to claim 5, wherein:
the lithium ion battery and the load are connected via a DC-DC converter; and
the electronic control unit is configured to estimate the inflow current based on a current flowing through the load and a conversion efficiency of the DC-DC converter.

8. The charge control device according to claim 7, wherein:
the DC-DC converter is of a step-down type; and
the electronic control unit is configured to estimate the inflow current based on a current conversion factor.
